(19) United States
(12) Patent Application Publication
(10) Pub. No.: US 2022/0102052 A1
(43) Pub. Date: Mar. 31, 2022

(54) MAGNETIC POWDER, MAGNETIC COMPACT, AND INDUCTOR

(71) Applicant: Murata Manufacturing Co., Ltd., Kyoto-fu (JP)

(72) Inventors: Keiichi ISHIDA, Nagaokakyo-shi (JP); Yoshinobu KIMURA, Nagaokakyo-shi (JP); Yoshihiko HATTORI, Nagaokakyo-shi (JP); Keita MUNEUCHI, Nagaokakyo-shi (JP); Nobuyuki FUJISAWA, Nagaokakyo-shi (JP)

(73) Assignee: Murata Manufacturing Co., Ltd., Kyoto-fu (JP)

(21) Appl. No.: 17/486,850

(22) Filed: Sep. 27, 2021

(30) Foreign Application Priority Data
Sep. 30, 2020 (JP) 2020-166443

(51) Int. Cl. H01F 27/255; H01F 3/08; H01F 1/20

(52) U.S. Cl. CPC H01F 27/255; H01F 1/20; H01F 3/08

(57) ABSTRACT

A magnetic powder contains first magnetic particles, second magnetic particles having a particle size larger than a particle size of the first magnetic particles, and resin. At least one portion of each of the second magnetic particles is covered by the resin and the first magnetic particles. Coverage (L1/L2)≥0.42 holds, where L1 is a sum of particle sizes of the first magnetic particles covering the second magnetic particle and L2 is a perimeter of the second magnetic particle.

This application claims benefit of priority to Japanese Patent Application No. 2020-166443 filed Sep. 30, 2020, the entire content of which is incorporated herein by reference.

### BACKGROUND

### Technical Field

The present disclosure relates to a magnetic powder, a magnetic compact, and an inductor.

### Background Art

Japanese Unexamined Patent Application Publication No. 2018-113436 describes a metal powder, obtained by blending two particle groups with different average particle sizes, the metal powder having a particle size distribution; a core (magnetic compact) manufactured using the metal powder; and an inductor manufactured using the core.

The inventor has become aware of that known magnetic powders have problems that have to be overcome and has found that measures against the problems need to be taken. In particular, the inventor has found a problem below.

The magnetic powder described in Japanese Unexamined Patent Application Publication No. 2018-113436 is one obtained by blending two particle groups with different average particle sizes. Blending particle groups by a usually known technique reduces the dispersibility and fluidity of particles with a large average size and particles with a small average size. Therefore, in resin, a sufficient number of the particles with a small average size are not placed into cavities between the particles with a large average size, the filling factor of a magnetic powder is low, and it is difficult to enhance the permeability. As a result, those manufactured using the magnetic powder described in Japanese Unexamined Patent Application Publication No. 2018-113436 have not been capable of having high permeability.

### SUMMARY

Accordingly, the present disclosure provides a magnetic powder, a magnetic compact, and an inductor that provide high permeability.

The inventor has not taken measures in line with known techniques and has attempted to address the above issues by taking measures in new directions.

According to a preferred embodiment of the present disclosure, a magnetic powder contains first magnetic particles, second magnetic particles having a particle size larger than a particle size of the first magnetic particles, and resin. At least one portion of each of the second magnetic particles is covered by the resin and the first magnetic particles. The following inequality holds:

coverage(L1/L2)≥0.42

where L1 is a sum of particle sizes of the first magnetic particles covering the second magnetic particle and L2 is a perimeter of the second magnetic particle.

According to a preferred embodiment of the present disclosure, a magnetic compact contains first magnetic particles, second magnetic particles having a particle size larger than a particle size of the first magnetic particles, and resin. Each of the second magnetic particles is surrounded by the first magnetic particles. The following inequality holds:

coverage(L1/L2)≥0.95

where L1 is a sum of particle sizes of the first magnetic particles surrounding the second magnetic particle and L2 is a perimeter of the second magnetic particle.

According to a preferred embodiment of the present disclosure, an inductor includes a coil conductor, and the above-mentioned magnetic compact, and the magnetic compact defines a winding core of the coil conductor.

A magnetic powder according to a preferred embodiment of the present disclosure satisfies the coverage (L1/L2)≥0.42 and therefore high permeability can be obtained in preparing a magnetic compact.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a schematic view of a cross-sectional SEM image of a magnetic powder according to an embodiment of the present disclosure;

FIG. 2 is a graph illustrating the relationship between the size and frequency of magnetic particles in the magnetic powder;

FIG. 3 is an illustration for describing a method for calculating the coverage of the magnetic powder;

FIGS. 4A and 4B are schematic process drawings illustrating a method for manufacturing a magnetic compact according to an embodiment of the present disclosure;

FIG. 5A is a perspective view of the magnetic compact;

FIG. 5B is a plan view of the magnetic compact;

FIG. 5C is a sectional view taken along the line a-a′ of FIG. 5A;

FIG. 6 is a schematic view of a cross-sectional SEM image of the magnetic compact;

FIG. 7 is a schematic perspective view illustrating a method for manufacturing an inductor according to an embodiment of the present disclosure;

FIG. 8 is a perspective view of the inductor; and

FIG. 9 is a front perspective view of the inductor.

### DETAILED DESCRIPTION

Embodiments of the present disclosure are described below in detail with reference to the attached drawings. The embodiments below are for exemplification only. The present disclosure is not limited to the embodiments.

Magnetic Powder

A magnetic powder according to an embodiment of the present disclosure is described below. The term “magnetic powder” as used herein refers to a particulate material used to manufacture a “magnetic compact”. The term “magnetic compact” as used herein, in a broad sense, refers to those used to increase the magnetic field in devices, such as inductors, generating a magnetic field and, in a narrow sense, refers to one used to cover a coil (conducting wire) in an inductor or one for use in a core of a coil (conducting wire) in an inductor.

First, raw materials for use in the magnetic powder are described. The raw materials for use in the magnetic powder may include first magnetic source particles, second magnetic source particles, resin, a solvent, and/or a curing agent. The raw materials for use in the magnetic powder may further include an additive such as a lubricant.

The first magnetic source particles used may be Fe-based magnetic metal particles hitherto used and may be made of, for example, Fe (pure iron) or an Fe alloy. Examples of the Fe alloy include alloys containing Fe and Ni; alloys containing Fe and Co; alloys containing Fe and Si; alloys containing Fe, Si, and Cr; alloys containing Fe, Si, and Al; alloys containing Fe, Si, B, and Cr; and alloys containing Fe, P, Cr, Si, B, Nb, and C. The first magnetic source particles may be particles of one or more magnetic metal materials selected from the group consisting of these alloys. Furthermore, the first magnetic source particles may be those with an insulated surface. The first magnetic source particles may have, for example, an insulating film on the surface thereof. The insulating film may be, for example, at least one selected from the group consisting of an inorganic glass film, an organic-inorganic hybrid film, and an inorganic insulating film formed by the sol-gel reaction of a metal alkoxide.

The second magnetic source particles used may be Fe-based magnetic metal particles hitherto used and may be made of, for example, Fe (pure iron) or an Fe alloy. Examples of the Fe alloy include alloys containing Fe and Ni; alloys containing Fe and Co; alloys containing Fe and Si; alloys containing Fe, Si, and Cr; alloys containing Fe, Si, and Al; alloys containing Fe, Si, B, and Cr; and alloys containing Fe, P, Cr, Si, B, Nb, and C. The second magnetic source particles may be particles of one or more magnetic metal materials selected from the group consisting of these alloys. The composition of the second magnetic source particles may be the same as or different from the composition of the first magnetic source particles. Furthermore, the second magnetic source particles may be those with an insulated surface. The second magnetic source particles may have, for example, an insulating film on the surface thereof. The insulating film may be, for example, at least one selected from the group consisting of an inorganic glass film, an organic-inorganic hybrid film, and an inorganic insulating film formed by the sol-gel reaction of a metal alkoxide.

The resin may contain a functional group contributing to a curing reaction. That is, a magnetic compact may be manufactured by the curing reaction of the resin. In particular, the resin in the magnetic powder at a stage prior to the manufacture of the magnetic compact is an uncured one. The term “uncured one” as used herein refers to one at a stage prior to an almost completely cured state and includes one in a partially cured state. An example of the resin may be at least one selected from the group consisting of an epoxy resin, a phenol resin, a polyester resin, a polyimide resin, a polyolefin resin, and a silicone resin. In particular, when the resin used is the epoxy resin, a magnetic compact with high electrically insulating properties and/or high mechanical strength can be obtained. Alternatively, a thermoplastic resin such as polyamide imide, polyphenylene sulfide, and/or a liquid crystal polymer may be used. The curing reaction is preferably induced by heat. That is, the resin is preferably a thermosetting resin. An example of the resin is a thermosetting epoxy resin. Using such resin enables the curing reaction to be induced by a simple method.

The solvent is used to obtain slurry by mixing the raw materials and is preferably an organic solvent. Examples of the solvent may include aromatic hydrocarbons such as toluene or xylene; ketones such as acetone, methyl ethyl ketone, or methyl isobutyl ketone; alcohols such as methanol, ethanol, or isopropyl alcohol; and glycol ethers such as propylene glycol monomethyl ether or propylene glycol monomethyl ether acetate.

The curing agent may be one used to cure the resin. Examples of the curing agent may include imidazole curing agents, amine curing agents, and guanidine curing agents such as dicyandiamide.

The lubricant may be used to enhance the lubricity of the first and second magnetic source particles and to increase the filling factor. Furthermore, the lubricant may be used to facilitate release from a die during molding. Examples of the lubricant may include nano-silica, barium sulfate, and stearates such as lithium stearate, magnesium stearate, zinc stearate, or potassium stearate.

For the weight percentage of the raw materials used to manufacture the magnetic powder, the first and second magnetic source particles may account for about 94% by weight to about 98% by weight on a total basis, the resin and the curing agent may account for about 1% by weight to about 5% by weight on a total basis, and the remainder may be the lubricant and the solvent. The ratio between the first magnetic source particles and the second magnetic source particles is preferably such that the ratio of the weight of the first magnetic source particles to the weight of the second magnetic source particles is about 10:90 to about 50:50. The ratio between the resin and the curing agent is preferably such that the ratio of the weight of the resin to the weight of the curing agent is about 95:5 to about 98:2.

Method for Manufacturing Magnetic Powder

Next, a method for manufacturing the magnetic powder is described. A method described below is merely an example. The method for manufacturing the magnetic powder is not limited to the method below.

First, the first magnetic source particles and the second magnetic source particles are prepared so as to have a small size and a large size, respectively. The insulating film may be formed on the surface of each of the first and second magnetic source particles. A process for forming the insulating film is not particularly limited and may be, for example, a mechanochemical process or a sol-gel process. The mechanochemical process is a low-cost technique that is particularly suitable for forming insulating films with a relatively large thickness on particles with a large size. In the case of forming the insulating film by the mechanochemical process, the thickness of the insulating film can be controlled by controlling the amount of an added insulating material. On the other hand, the sol-gel process is applicable to particles with various compositions and sizes and can form insulating films with a relatively small thickness. The sol-gel process can form insulating films with a relatively high melting point. In the case of forming the insulating film by the sol-gel process, the thickness of the insulating film can be controlled by adjusting, for example, the time of a sol-gel reaction, the amount of an added metal alkoxide, the amount of the added solvent, and the like. Among the prepared first and second magnetic source particles, the second magnetic source particles are placed into a mixing vessel and are mixed in the mixing vessel.

Next, a particle raw material containing the first magnetic source particles, which have a small size, the resin, the solvent, and the curing agent is mixed, whereby slurry is obtained. The slurry is poured into a sprayer. An example of the sprayer is a device capable of spraying mist. In particular, a spray atomizer is cited. The lubricant may be contained in the particle raw material. That is, the lubricant is not an essential component of the particle raw material. In the particle raw material poured into the sprayer, the weight percentage of the solvent may be about 1.0% by weight to about 5.0% by weight on the basis of the weight of the whole material (the first magnetic source particles, the second magnetic source particles, the resin, the curing agent, the solvent, and/or the lubricant) used.

Next, the particle raw material, which contains the first magnetic source particles, is sprayed on the second magnetic source particles mixed in the mixing vessel using the sprayer. The term “spray” as used herein means that liquid is sprayed in the form of mist. The above spray is preferably performed at a temperature of about 30° C. to about 80° C. in an air or N₂ atmosphere. The solvent in the particle raw material may be evaporated by spraying the first magnetic source particles on the second magnetic source particles at such a temperature. The particle raw material, which contains the first magnetic source particles, is sprayed on the second magnetic source particles by using the sprayer as described above, whereby the first magnetic source particles are uniformly dispersed around the second magnetic source particles. Thus, when a magnetic compact is prepared, the first magnetic source particles and the second magnetic source particles are likely to be uniformly arranged, the first magnetic source particles are filled in cavities between the second magnetic source particles such that hollows are unlikely to occur, the filling factor of the first and second magnetic source particles can be increased, and high permeability can be obtained. A precursor containing the first magnetic source particles and the second magnetic source particles is mixed in the mixing vessel, whereby the first magnetic source particles and the second magnetic source particles are uniformly dispersed.

Thereafter, the solvent is evaporated from the precursor and the precursor is shaken in a sieve shaker with a mesh size of about 160 μm to about 200 μm such that coarse particles are removed from the precursor, whereby the magnetic powder is obtained. In the magnetic powder, no curing reaction has occurred in the resin. That is, the resin is in an uncured or partially cured state. In this manner, the magnetic powder is obtained such that the first magnetic source particles are attached to each second magnetic source particle with the resin. In this embodiment, a mode of using the first magnetic source particles and the second magnetic source particles has been described. Third magnetic source particles, fourth magnetic source particles, or the like having a composition, average size, and/or the like different from that of the first and second magnetic source particles may be additionally used.

Technique for Analyzing Magnetic Powder

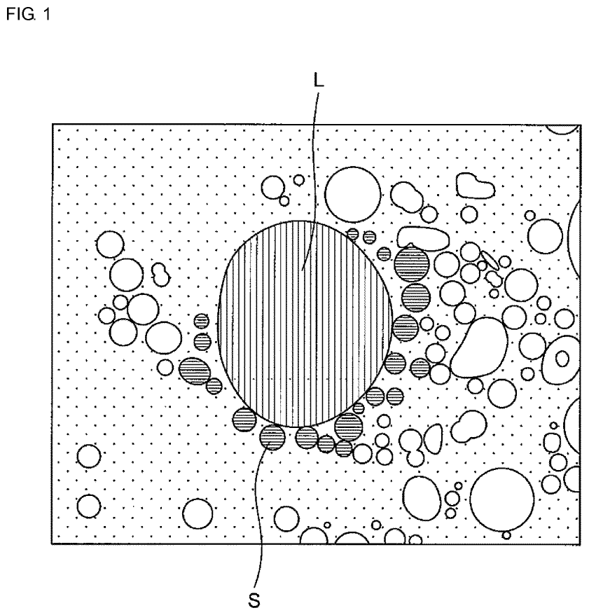

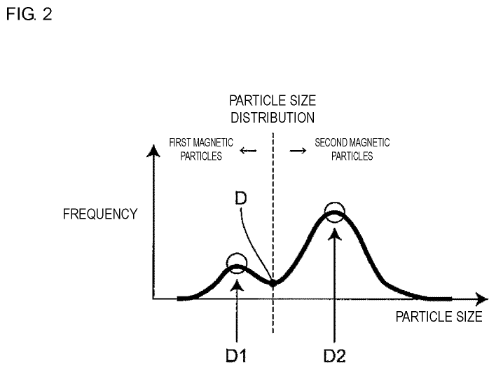

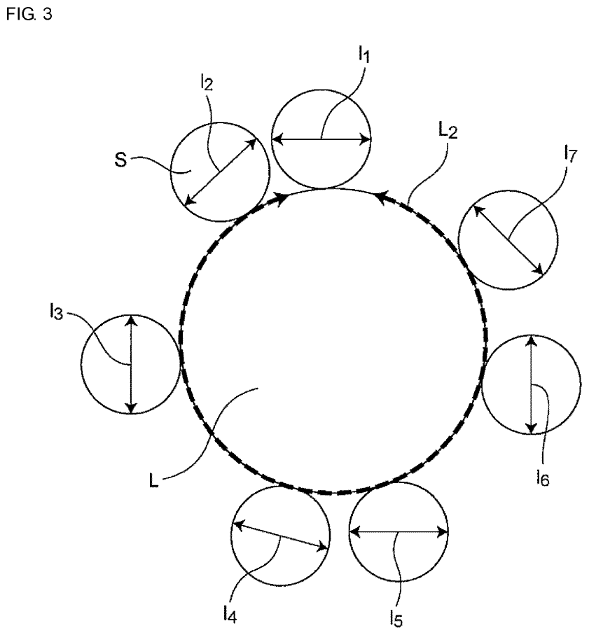

Next, a technique for analyzing the magnetic powder manufactured by the above-mentioned method is described with reference to FIGS. 1 to 3. FIG. 1 is a schematic view of a cross-sectional SEM image of the magnetic powder. FIG. 2 is a graph illustrating the relationship between the size and frequency of magnetic particles in the magnetic powder. FIG. 3 is an illustration for describing a method for calculating the coverage of the magnetic powder.

The manufactured magnetic powder is observed mainly using a scanning electron microscope (SEM). In order to obtain a SEM image, a cross section of a sample obtained by binding the magnetic powder with resin is polished and is processed with an ion milling system and the processed sample is introduced into a SEM system. The cross section thereof is observed at about 500× to about 2,000× magnification. A schematic view of an obtained cross-sectional SEM image is illustrated in FIG. 1.

Furthermore, image analysis is performed for the obtained cross-sectional SEM image using image analysis software, WinROOF 2018, developed by Mitani Corporation and the particle size distribution of the magnetic powder is determined from the image analysis. In particular, the size (equivalent circle diameter) of each particle is calculated by the binarization of the obtained cross-sectional SEM image, the shape of the particle is supposed to be substantially a sphere with the calculated equivalent circle diameter, and the frequency of the particles is counted, whereby the relationship between the size and frequency of the particles on a volume basis is graphed and the particle size distribution is obtained. A graph obtained by the image analysis is illustrated in FIG. 2. According to the graph illustrated in FIG. 2, the manufactured magnetic powder has a first peak value and a second peak value with a particle frequency higher than that of the first peak value. Furthermore, the magnetic powder has a bottom value between the first peak value and the second peak value. The particle size corresponding to the bottom value is calculated as D. The number of peak values is not limited to two and may be three or more. In response to this, a plurality of bottom values may be present. When the magnetic powder has a plurality of bottom values, the particle size corresponding to the smallest bottom value is defined as D. In the obtained particle size distribution, particles having a size (equivalent circle diameter) less than the particle size D are the first magnetic particles and particles having a size (equivalent circle diameter) larger than the particle size D are the second magnetic particles. In this embodiment, a particle size D1 corresponding to the first peak value is equivalent to the modal size of the first magnetic particles and a particle size D2 corresponding to the second peak value is equivalent to the modal size of the second magnetic particles. Furthermore, the particle size corresponding to the bottom value between the first peak value and the second peak value is defined as D.

As used herein, the term “first magnetic particle” refers to a particle with a size (equivalent circle diameter) less than the particle size D corresponding to the bottom value and the term “second magnetic particle” refers to a particle with a size (equivalent circle diameter) larger than the particle size D corresponding to the bottom value. Furthermore, as used herein, the term “the modal size of the first magnetic particles” refers to the particle size at the highest particle frequency in a region of a particle size less than the particle size D in the graph illustrating the relationship between the size and frequency of the magnetic particles in the magnetic powder and the term “the modal size of the second magnetic particles” refers to the particle size at the highest particle frequency in a region of a particle size larger than the particle size D in the graph illustrating the relationship between the size and frequency of the magnetic particles in the magnetic powder.

In this embodiment, the first magnetic particles preferably have a modal size of about 0.5 μm to about 8 μm and more preferably about 1 μm to about 5 μm. The second magnetic particles have a size larger than that of the first magnetic particles. The second magnetic particles preferably have a modal size of about 10 wn to about 50 wn. When the modal size of the second magnetic particles is about 50 μm or less, the eddy-current loss can be reduced. The modal size of the second magnetic particles is more preferably about 20 wn to about 40 μm. Furthermore, (the modal size of the first magnetic particles)/(the modal size of the second magnetic particles) is preferably about 0.02 to about 0.5. In this case, the filling factor of the magnetic particles can be increased. In the magnetic compact, the filling factor of the magnetic particles is preferably about 0.75 or more.

The coverage of each second magnetic particle covered by the first magnetic particles is calculated using the cross-sectional SEM image (refer to FIG. 1) of the magnetic powder and results of the particle size distribution (refer to FIG. 2) of the magnetic particles in the magnetic powder. A method for calculating the coverage is described below.

The second magnetic particles have a size (equivalent circle diameter) larger than the particle size D2 determined from a graph of a particle size distribution and are selected as large particles intended to be analyzed. In this embodiment, the second magnetic particles that have a size larger than the particle size D2 corresponding to the second peak value determined from the graph illustrated in FIG. 2 are selected. In, for example, the schematic view of the cross-sectional SEM image illustrated in FIG. 1, a second magnetic particle L selected as a large particle intended to be analyzed is vertically hatched. The first magnetic particles of which at least one portion is included within the distance given by (particle size D1)/2 from the outline of the second magnetic particle L are selected as small particles intended to be analyzed and are referred to as first magnetic particles S. In the schematic view of the cross-sectional SEM image illustrated in FIG. 1, the selected first magnetic particles S are horizontally hatched.

FIG. 3 illustrates a schematic view of the selected second magnetic particle L and the first magnetic particles S. Image analysis is performed for such an image as described above and L2 that is the perimeter of the second magnetic particle L, which is a large particle, and L1 that is the sum (the sum of l₁ to l₇) of the sizes (equivalent circle diameters) of the first magnetic particles S, which are small particles, are calculated. The value of L1/L2 is determined from calculated L1 and L2. For 20 second magnetic particles L that are randomly selected, the value of L1/L2 is determined and the average thereof is defined as the coverage. In the magnetic powder, the coverage (L1/L2)≥0.42 holds and the coverage (L1/L2)≥0.50 preferably holds. The term “coverage” as used herein refers to an indicator of how much a large particle is covered by small particles and means that as the value of coverage is larger, the large particle is more covered by the small particles. In this embodiment, a mode of determining a particle size distribution using a cross-sectional SEM image has been described. In the case of determining the particle size distribution of powdery magnetic particles used as a raw material, a laser diffraction technique or a laser scattering technique can be used.

Magnetic Compact Containing Magnetic Powder

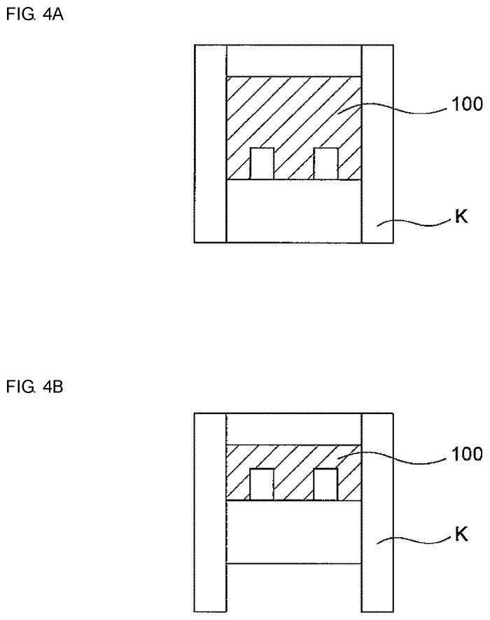

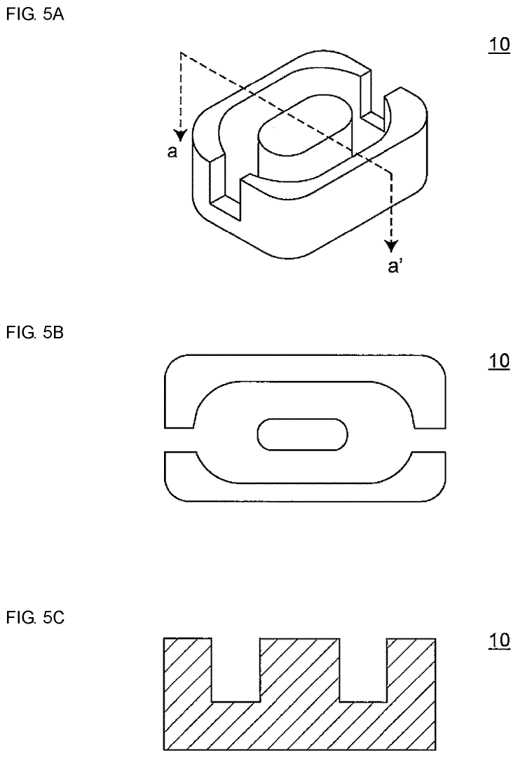

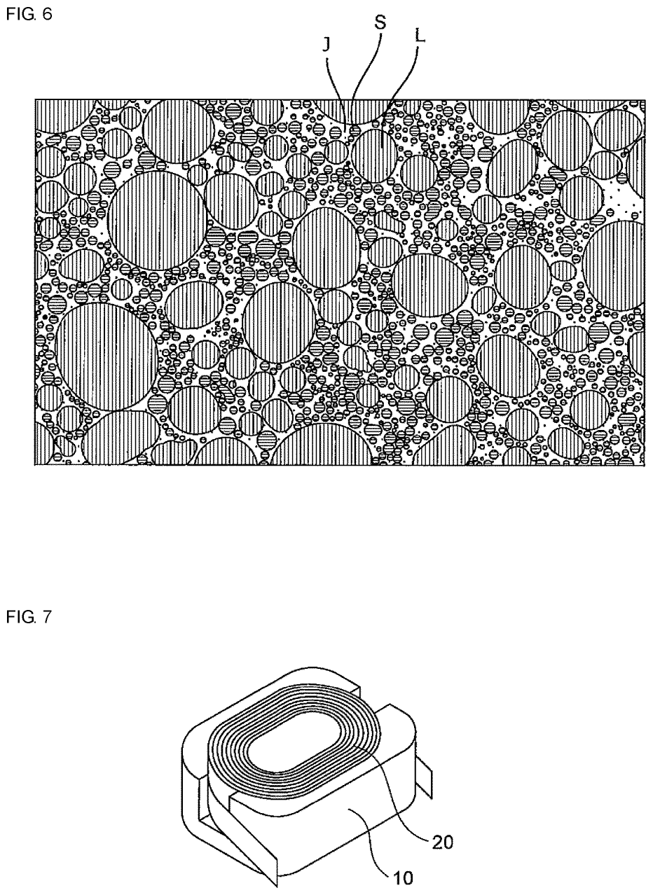

Next, a magnetic compact according to an embodiment of the present disclosure is described. The magnetic compact contains the above-mentioned magnetic powder. First, a method for manufacturing the magnetic compact is described with reference to FIGS. 4A to 6. FIGS. 4A and 4B are schematic process drawings illustrating the method for manufacturing the magnetic compact. FIG. 5A is a perspective view of the magnetic compact. FIG. 5B is a plan view of the magnetic compact. FIG. 5C is a sectional view taken along the line a-a′ of FIG. 5A. FIG. 6 is a schematic view of a cross-sectional SEM image of the magnetic compact. Referring to FIG. 6, the symbol J represents resin.

Method for Manufacturing Magnetic Compact

The magnetic compact is a substantially E-shaped core with substantially an E-shape in cross section. A method for manufacturing the substantially E-shaped core is described below. The magnetic compact is not limited to the substantially E-shaped core and may be, for example, at least one selected from the group consisting of a substantially I-shaped core, a substantially T-shaped core, a substantially plate-shaped core, and a substantially toroidal ring-shaped core.

First, a die K for manufacturing the substantially E-shaped core is prepared. As illustrated in FIG. 4A, the magnetic powder 100 is filled into the die K. As illustrated in FIG. 4B, the die K may be introduced into a compression molding machine and may be pressed with about 50 MPa to about 150 MPa at about 20° C. to about 40° C. for about 30 s or less. The magnetic powder 100 contains the thermosetting resin as described above. Since the temperature during pressing is relatively low, about 20° C. to about 40° C., the curing reaction does not proceed and the thermosetting resin may be in an uncured or partially cured state. After pressing, the magnetic compact may be taken out of the die K.

The magnetic compact 10 may be stored in such a state that the thermosetting resin is uncured or partially cured. That is, when an almost completely cured magnetic compact as a product needs to be manufactured, the magnetic compact may be manufactured in such a manner that the magnetic compact 10 in a partially cured state is packed into a die different from the die K and the resin is almost completely cured under conditions including a temperature of about 150° C. to about 200° C., a pressure of about 5 MPa to about 50 MPa, and a time of about 60 s to about 1,800 s as illustrated in FIGS. 5A to 5C. The magnetic compact 10 may be prepared in such a manner that a plurality of sheets containing the magnetic powder are formed, are stacked, are pressure-bonded, and are heat-cured.

Technique for Analyzing Magnetic Compact

Next, a technique for analyzing the magnetic compact manufactured by the above method is described. The technique for analyzing the magnetic compact is similar to the above technique for analyzing the magnetic powder. That is, the following technique is used: a technique in which the coverage of each second magnetic particle surrounded by the first magnetic particles is calculated using a cross-sectional SEM image (refer to FIG. 6) of the magnetic compact and results of the particle size distribution of the magnetic compact. A cross section for obtaining a SEM image is obtained by ion-milling a fracture surface of almost the center of the magnetic compact. In the magnetic compact in a partially cured state, the coverage (L1/L2)≥0.78 holds. In the magnetic compact in an almost completely cured state, the coverage (L1/L2)≥0.95 holds. In the magnetic compact in a partially cured state, the coverage (L1/L2)≥0.83 preferably holds. In the magnetic compact in an almost completely cured state, the coverage (L1/L2)≥1.09 preferably holds.

Furthermore, the filling factor of magnetic particles can be measured from the above-mentioned cross-sectional SEM image. In particular, the cross-sectional SEM image is obtained in substantially the same manner as that used to measure the coverage in the magnetic compact. The percentage of the area occupied by the magnetic particles in the area of an observed region is determined by the binarization of the obtained cross-sectional SEM image. The percentage of the area occupied by the magnetic particles in the area of an observed region is determined in ten places that are randomly selected and the average thereof is defined as the filling factor of the magnetic particles. This enables the filling factor of the magnetic particles to be measured.

Inductor

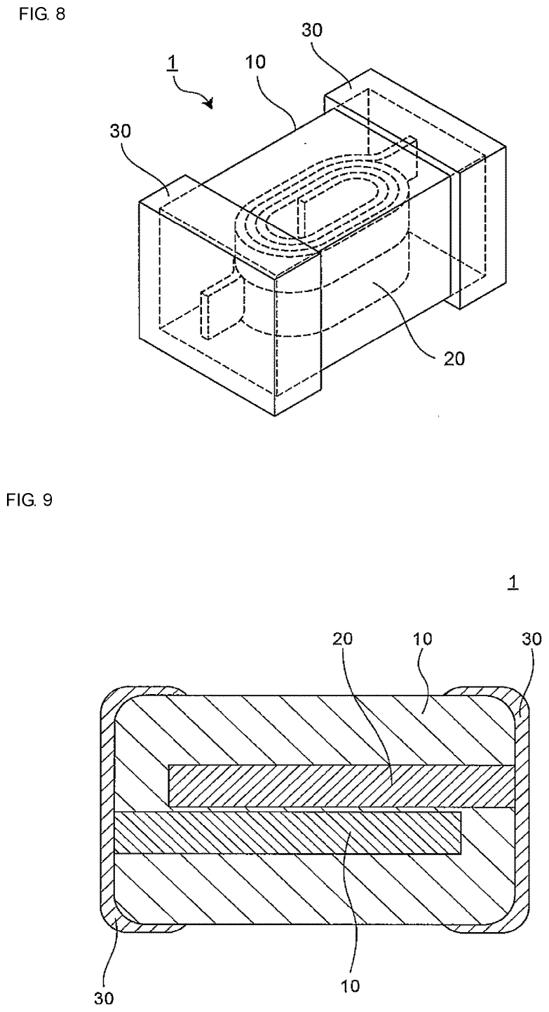

Next, an inductor according to an embodiment of the present disclosure is described. The inductor includes the above-mentioned magnetic compact. First, a method for manufacturing the inductor is described with reference to FIGS. 7 to 9. FIG. 7 is a schematic perspective view illustrating the method for manufacturing the inductor. FIG. 8 is a perspective view of the inductor. FIG. 9 is a front perspective view of the inductor.

Method for Manufacturing Inductor

A conducting wire 20 to be wound on the magnetic compact 10 is prepared. The conducting wire 20 is preferably prepared by covering, for example, a metal wire such as a flat copper wire with resin or the like. In this case, the conducting wire 20 can be tightly molded in association with the resin contained in the magnetic compact 10. The conducting wire 20 is preferably wound by alpha-winding such that the winding start and the winding end are wound toward an outer side portion together. Winding the conducting wire 20 by alpha-winding allows the winding end to be located outside and therefore an extended portion can be readily handled.

Next, the magnetic compact 10 of which the resin is in an uncured or partially cured state is prepared. The conducting wire 20 wound by alpha-winding is placed into the magnetic compact 10. That is, the magnetic compact 10 defines a winding core of a coil conductor. In this operation, a portion of an E-shaped core is inserted into a winding core of the conducting wire 20 as illustrated in FIG. 7. Furthermore, the above-mentioned magnetic powder may be used to cover the conducting wire 20 such that the conducting wire 20 is hidden in the magnetic powder. After the conducting wire 20, the magnetic compact 10, and the magnetic powder are placed into the above-mentioned die, the die is introduced into a compression molding machine. The resin contained in the magnetic compact 10 is cured under conditions including a temperature of about 150° C. to about 200° C., a pressure of about 5 MPa to about 50 MPa, and a time of about 60 s to about 1,800 s, whereby an element body for the inductor is formed.

Next, edges of the element body may be rounded by polishing the element body by barreling. Rounding the edges enables the breakage of outer electrodes formed thereafter to be reduced. Thereafter, outer electrodes 30 are formed on the element body. A process for forming the outer electrodes 30 may be a plating process, a process in which a conductive paste is applied on the element body and is baked, a sputtering process, or the like (refer to FIGS. 8 and 9). Examples of the outer electrodes 30 include those obtained by heat-curing a conductive resin paste containing an Ag powder, Ni coatings, and Sn coatings. The outer electrodes 30 may have a structure formed by laminating those.

As described above, the inductor can be manufactured using the above-mentioned magnetic powder and magnetic compact. Referring to FIG. 8, cross sections of the conducting wire 20 that intersect an extending direction of the conducting wire 20 are exposed at surfaces of the element body and are connected to the outer electrodes 30. The conducting wire 20 may be connected to the outer electrodes 30 in such a manner that both end portions of the conducting wire 20 are bent such that side surfaces of the conducting wire 20 that are parallel to the extending direction of the conducting wire 20 are exposed at surfaces of the element body.

### Examples

Magnetic Powders

Next, examples of the present disclosure are described. Magnetic powders were manufactured in the examples and comparative examples below and were subjected to a verification test.

Raw materials used to manufacture magnetic powders in Examples 1 and 2 and Comparative Examples 1 and 2 were illustrated below. In each of Examples 1 and 2, a magnetic powder was manufactured through a step of spraying a particle raw material containing first magnetic source particles on second magnetic source particles in a 60° C. environment as described in the method for manufacturing the magnetic powder according to the above embodiment. On the other hand, in each of Comparative Examples 1 and 2, resin and a solvent were added to the first and second magnetic source particles mixed in a mixing vessel and a curing agent and a lubricant were subsequently added thereto, whereby a granular powder was obtained. The granular powder was dried at 60° C., whereby the solvent was evaporated. In this stage, the second magnetic source particles were attached to each other. Therefore, crushing was performed with a crusher such that the second magnetic source particles were isolated from each other, followed by removing coarse particles using a sieve as is the case with an example, whereby a magnetic powder was obtained. In Examples 1 and 2 and Comparative Examples 1 and 2, a sieve used to remove coarse particles had a mesh size of 180 μm.

The raw materials used to manufacture the magnetic powders in Examples 1 and 2 and Comparative Examples 1 and 2 were as described below.

First magnetic particles: a D50 size of 4.0 μm, an Fe-6.7Si-2.5Cr amorphous alloy (an Fe-to-Si-to-Cr weight ratio of 90.8:6.7:2.5)

Second magnetic particles: a D50 size of 28 μm, the Fe-6.7Si-2.5Cr amorphous alloy (an Fe-to-Si-to-Cr weight ratio of 90.8:6.7:2.5)

Resin: a thermosetting epoxy resin

Solvent: acetone

Curing agent: imidazole

Lubricant: nano-silica particles with a diameter of 50 nm

In the magnetic powder manufactured in Example 1, the first and second magnetic particles accounted for 96.0% by weight of the magnetic powder, the resin and the curing agent accounted for 3.6% by weight of the magnetic powder, and the lubricant accounted for 0.4% by weight of the magnetic powder. The solvent used accounted for 4.6% by weight of the whole of the raw materials (the first magnetic particles, the second magnetic particles, the resin, the solvent, the curing agent, and the lubricant) and was evaporated off in the manufacture of the magnetic powder.

In the magnetic powder manufactured in Example 1, the weight ratio of the first magnetic particles to the second magnetic particles was 25:75 and the weight ratio of the resin to the curing agent was 97.4:2.6.

In the magnetic powder manufactured in Example 2, the first and second magnetic particles accounted for 96.5% by weight of the magnetic powder, the resin and the curing agent accounted for 3.1% by weight of the magnetic powder, and the lubricant accounted for 0.4% by weight of the magnetic powder. The solvent used accounted for 4.1% by weight of the whole of the raw materials and was evaporated off in the manufacture of the magnetic powder.

In the magnetic powder manufactured in Example 2, the weight ratio of the first magnetic particles to the second magnetic particles was 25:75 and the weight ratio of the resin to the curing agent was 97.4:2.6.

In the magnetic powder manufactured in Comparative Example 1, the first and second magnetic particles accounted for 96.0% by weight of the magnetic powder, the resin and the curing agent accounted for 3.6% by weight of the magnetic powder, and the lubricant accounted for 0.4% by weight of the magnetic powder. The solvent used accounted for 4.6% by weight of the whole of the raw materials and was evaporated off in the manufacture of the magnetic powder.

In the magnetic powder manufactured in Comparative Example 1, the weight ratio of the first magnetic particles to the second magnetic particles was 25:75 and the weight ratio of the resin to the curing agent was 97.4:2.6.

In the magnetic powder manufactured in Comparative Example 2, the first and second magnetic particles accounted for 96.5% by weight of the magnetic powder, the resin and the curing agent accounted for 3.1% by weight of the magnetic powder, and the lubricant accounted for 0.4% by weight of the magnetic powder. The solvent used accounted for 4.1% by weight of the whole of the raw materials and was evaporated off in the manufacture of the magnetic powder.

In the magnetic powder manufactured in Comparative Example 2, the weight ratio of the first magnetic particles to the second magnetic particles was 25:75 and the weight ratio of the resin to the curing agent was 97.4:2.6.

Next, for Examples 1 and 2 and Comparative Examples 1 and 2, a cross-sectional SEM image was obtained and the coverage was determined. As a result, results illustrated in Table 1 were obtained. A method used to calculate the coverage was the method described in above-mentioned “Technique for Analyzing Magnetic Powder”.

TABLE 1

| | Coverage |
|---|---|
| Example 1 | 0.50 |
| Example 2 | 0.42 |
| Comparative Example 1 | 0.28 |
| Comparative Example 2 | 0.27 |

As is clear from the results illustrated in Table 1 above, high coverage was obtained in Examples 1 and 2 as compared to that in Comparative Examples 1 and 2. That is, the coverage of the magnetic powder manufactured in each of Comparative Examples 1 and 2 was less than 0.42. However, the coverage of the magnetic powder manufactured in each of Examples 1 and 2 was 0.42 or more.

Magnetic Compacts

Next, a magnetic compact with a toroidal ring shape was manufactured using the magnetic powder manufactured in each of Examples 1 and 2 and Comparative Examples 1 and 2. In each of Examples 1 and 2 and Comparative Examples 1 and 2, a method used to manufacture the magnetic compact was the method described in above-mentioned “Method for Manufacturing Magnetic Compact”. First, the magnetic powder was pressed in a first die with 100 MPa at 30° C. for ten seconds. Subsequently, the magnetic powder was pressed in a second die with 20 MPa at 180° C. for 600 seconds such that the resin was cured, whereby the magnetic compact was manufactured. A cross-sectional SEM image of the manufactured magnetic compact was obtained, followed by determining the coverage. As a result, results below were obtained. A method used to calculate the coverage was the method described in above-mentioned “Technique for Analyzing Magnetic Powder”. Results of calculating the coverage were illustrated in Table 2. Furthermore, results of measuring the filling factor of magnetic particles measured by the technique described in above-mentioned “Technique for Analyzing Magnetic Powder” were illustrated in Table 2.

TABLE 2

| | Coverage | Filling factor of magnetic particles |
|---|---|---|
| Example 1 | 1.09 | 0.79 |
| Example 2 | 0.95 | 0.78 |
| Comparative Example 1 | 0.86 | 0.76 |
| Comparative Example 2 | 0.82 | 0.75 |

As is clear from the results illustrated in Table 2 above, high coverage was obtained in Examples 1 and 2 as compared to that in Comparative Examples 1 and 2. That is, the coverage of the magnetic compact manufactured in each of Comparative Examples 1 and 2 was less than 0.95.

However, the coverage of the magnetic compact manufactured in each of Examples 1 and 2 was 0.95 or more.

Next, the magnetic compacts manufactured in Examples 1 and 2 and Comparative Examples 1 and 2 were measured for relative permittivity. In the measurement of the relative permittivity, an impedance analyzer, E4294A, available from Keysight Technologies Inc. was used and the measurement frequency used was 1 MHz. Results of measuring the relative permittivity were illustrated in Table 3. Incidentally, the term “relative permittivity” as used herein refers to the ratio μs=μ/μ₀, where μ is the permeability of material and μ₀ is the permeability of a vacuum.

TABLE 3

| | Relative permeability |
|---|---|
| Example 1 | 25.2 |
| Example 2 | 24.3 |
| Comparative Example 1 | 23.2 |
| Comparative Example 2 | 23.1 |

As is clear from the results illustrated in Table 3 above, high relative permittivity was obtained in Examples 1 and 2 as compared to that in Comparative Examples 1 and 2. That is, the relative permittivity of the magnetic compact manufactured in each of Comparative Examples 1 and 2 was less than 23.5. However, the relative permittivity of the magnetic compact manufactured in each of Examples 1 and 2 was 23.5 or more. In particular, the relative permittivity of an inductor manufactured in each of Examples 1 and 2 was 24 or more.

The embodiments disclosed this time are illustrative in all respects and do not serve as a basis for limited interpretation. Thus, the technical scope of the present disclosure is not interpreted only by the embodiments and is defined by the appended claims. The technical scope of the present disclosure includes all modifications within the sense and scope equivalent to the claims.

A magnetic powder, magnetic compact, and inductor according to the present disclosure can exhibit high permeability and therefore can be successfully used in electronic components required to have high magnetic characteristics.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A magnetic powder containing:
first magnetic particles;
second magnetic particles having a particle size larger than a particle size of the first magnetic particles; and
resin,
wherein at least a portion of each of the second magnetic particles is covered by the resin and the first magnetic particles, and
where L1 is a sum of particle sizes of the first magnetic particles covering the second magnetic particle and L2 is a perimeter of the second magnetic particle, the following expression is satisfied
coverage (L1/L2)≥0.42.

2. The magnetic powder according to claim 1, wherein
the coverage (L1/L2)≥0.50 is satisfied.

3. The magnetic powder according to claim 1, wherein
the magnetic powder has a bottom value at which a particle frequency is smallest among a plurality of peak values in a particle size distribution indicating a relationship between the particle frequency and a particle size,
the particle size of the first magnetic particles is less than the bottom value, and
the particle size of the second magnetic particles is larger than the bottom value.

4. The magnetic powder according to claim 3, wherein
the L1 is the sum of the particle sizes of the first magnetic particles of which at least a portion is included within a distance given by (particle size D1)/2 from an outline of the second magnetic particle, where D1 is a particle size at the highest particle frequency in a particle size range less than the bottom value of the particle frequency in the particle size distribution.

5. The magnetic powder according to claim 1, wherein
the first magnetic particles and the second magnetic particles are magnetic metal particles.

6. The magnetic powder according to claim 5, wherein
the magnetic metal particles contain at least one selected from the group consisting of Fe; an alloy containing Fe and Ni; an alloy containing Fe and Co; an alloy containing Fe and Si; an alloy containing Fe, Si, and Cr; an alloy containing Fe, Si, and Al; an alloy containing Fe, Si, B, and Cr; and an alloy containing Fe, P, Cr, Si, B, Nb, and C.

7. The magnetic powder according to claim 1, wherein
the resin is a thermosetting resin.

8. The magnetic powder according to claim 1, wherein
the resin is uncured.

9. The magnetic powder according to claim 2, wherein
the magnetic powder has a bottom value at which a particle frequency is smallest among a plurality of peak values in a particle size distribution indicating a relationship between the particle frequency and a particle size,
the particle size of the first magnetic particles is less than the bottom value, and
the particle size of the second magnetic particles is larger than the bottom value.

10. The magnetic powder according to claim 2, wherein
the first magnetic particles and the second magnetic particles are magnetic metal particles.

11. The magnetic powder according to claim 3, wherein
the first magnetic particles and the second magnetic particles are magnetic metal particles.

12. The magnetic powder according to claim 2, wherein
the resin is a thermosetting resin.

13. The magnetic powder according to claim 2, wherein
the resin is uncured.

14. A magnetic compact containing:
first magnetic particles;
second magnetic particles having a particle size larger than a particle size of the first magnetic particles; and
resin,
wherein each of the second magnetic particles is surrounded by the first magnetic particles, and
where L1 is a sum of particle sizes of the first magnetic particles surrounding the second magnetic particle and L2 is a perimeter of the second magnetic particle, the following expression is satisfied
coverage (L1/L2)≥0.95.

15. The magnetic compact according to claim 14, wherein
the coverage (L1/L2)≥1.09 is satisfied.

16. The magnetic compact according to claim 14, wherein
the magnetic compact has a bottom value at which a particle frequency is smallest among a plurality of peak values in a particle size distribution indicating a relationship between the particle frequency and a particle size,
the particle size of the first magnetic particles is less than the bottom value and,
the particle size of the second magnetic particles is larger than the bottom value.

17. The magnetic compact according to claim 16, wherein
the L1 is the sum of the particle sizes of the first magnetic particles of which at least a portion is included within a distance given by (particle size D1)/2 from an outline of the second magnetic particle, where D1 is a particle size at the highest particle frequency in a particle size range less than the bottom value of the particle frequency in the particle size distribution.

18. An inductor comprising:
a coil conductor; and
the magnetic compact according to claim 14 defines a winding core of the coil conductor.

19. The magnetic compact according to claim 15, wherein
the magnetic compact has a bottom value at which a particle frequency is smallest among a plurality of peak values in a particle size distribution indicating a relationship between the particle frequency and a particle size,
the particle size of the first magnetic particles is less than the bottom value and,
the particle size of the second magnetic particles is larger than the bottom value.

20. An inductor comprising:
a coil conductor; and
the magnetic compact according to claim 15 defines a winding core of the coil conductor.
